(19) United States
(12) Patent Application Publication
(10) Pub. No.: US 2007/0084784 A1
(43) Pub. Date: Apr. 19, 2007

(54) Fuel delivery unit

(75) Inventor: Bernd Wehrum, Rotenburg (DE)

Correspondence Address: MAYER, BROWN, ROWE & MAW LLP, P.O. BOX 2828, CHICAGO, IL, 60690-2828, US

(73) Assignee: SIEMENS AKTIENGESELLSCHAFT, Munich (DE)

(21) Appl. No.: 10/580,350

(22) PCT Filed: Oct. 29, 2004
(86) PCT No.: PCT/EP04/52713

§ 371 Date: May 23, 2006

(30) Foreign Application Priority Data
Nov. 27, 2003 (DE) 103 55 309.6

(51) Int. Cl. B01D 24/00; F02M 37/04

(52) U.S. Cl. 210/416.4; 123/509

(57) ABSTRACT

The invention relates to a fuel delivery unit (2) wherein a space between a baffle pot (3) and a fuel pump (4) is filled with filter material (13) of a fuel filter (6). The baffle pot (3) is injection-molded onto the filter material (13) and is provided with a recess (14) for directly receiving the fuel pump (4). The fuel delivery unit (2) has an especially simple design and can be easily installed.

### BACKGROUND OF THE INVENTION

The invention relates to a fuel delivery unit having a surge pot and a fuel pump which is fastened in the surge pot, having a fuel filter and having a sealing connection of the fuel filter to the surge pot and to the fuel pump.

Fuel delivery units of said type are frequently used in modern-day motor vehicles and are known from practice. The fuel filter, which is arranged within the surge pot, is usually embodied as a fine filter and filters the fuel which is drawn from a main stage. A prefilter, which is arranged in the drawing region of a preliminary stage of the fuel delivery unit, is situated outside the surge pot. The preliminary stage delivers fuel from the fuel tank, through the prefilter, into the surge pot. The fuel filter is usually arranged in the central region of the surge pot and has a housing through which fuel flows axially, said housing having a filter element arranged within it. A disadvantage of the known fuel delivery unit is that the filter effect through the filter element is very limited. The filter element can quickly become clogged with dirt particles, leading to severe impairment of the filter effect.

The problem on which the invention is based is therefore that of configuring a fuel delivery unit of the type mentioned in the introduction in such a way that it has a good filter effect and a high dirt absorption capacity.

### BRIEF DESCRIPTION OF THE INVENTION

According to the invention, said problem is solved in that a filter material almost completely fills a space between the surge pot and the fuel pump.

With this configuration, the fuel filter has the largest possible dimensions, leading to a particularly good filter effect. Dirt particles can be deposited in the filter material without directly leading to the fuel filter becoming clogged. As a result, the fuel delivery unit according to the invention has a particularly high dirt absorption capacity. In addition, with this configuration, fuel pump noise is largely damped by the filter material.

According to one advantageous refinement of the invention, the filter material can be connected to the surge pot with particularly little outlay if the filter material is connected to the surge pot in a cohesive fashion.

According to another advantageous refinement of the invention, the filter material can be produced in one piece with the surge pot with particularly little outlay if the filter material is injection-molded into the surge pot. This contributes to a simplification of assembly of the fuel delivery unit according to the invention.

According to another advantageous refinement of the invention, fuel pump noise can be particularly easily damped if the filter material is embodied as damping material of the fuel pump.

According to another advantageous refinement of the invention, the fuel pump can be easily retrospectively mounted in the surge pot and exchanged if the filter material of the fuel filter has a recess for directly holding the fuel pump. In addition, as a result, the fuel delivery unit according to the invention does not require any complex housing for fastening it to the fuel pump, since the filter material can directly hold the fuel pump.

According to another advantageous refinement of the invention, the assembly of the fuel pump can be further simplified if the fuel pump has an interference fit in the recess of the filter material.

According to another advantageous refinement of the invention, the filter material fulfils a retaining function for the fuel if the filter material has a sponge-like structure. This ensures that the filter material draws fuel fully even when the fuel tank is nearly empty. As a result, the fuel pump is reliably supplied with fuel even when the fuel tank is nearly empty.

According to another advantageous refinement of the invention, the fuel filter can be mounted retrospectively with particularly little outlay if the filter material is plugged into the surge pot. As a result, the filter material can be produced separately from the fuel pump and the surge pot with an outer diameter which corresponds to the inner diameter of the surge pot, and can be inserted into the surge pot retrospectively.

According to another advantageous refinement of the invention, the filter element can be mechanically re-worked in a particularly simple manner, and can be easily connected to other components by means of integrally cast parts, if the filter material is produced from open-cell metal foam. By way of example, magnesium foam or aluminum foam are particularly suitable as an open-cell metal foam of said type. Metal foams of said type can be simply produced if a foaming agent is added to a metal melt and the mixture is introduced into a mold. As the foaming agent decomposes, mainly hydrogen is released, so that a magnesium foam is produced which hardens in the mold. Alternatively, salt can also be added to the melt, and the salt is then washed out after the melt has hardened. As a result, small foam structures can be created which have low variation in material properties.

According to another advantageous refinement of the invention, low pressure losses can be obtained as flow passes through the filter material if the filter material is produced from polymer foam. So-called SGS polymers are particularly suitable as polymer foam. A polymer foam of said type is a fuel-resistant plastic which has a uniform porous structure. As a result, the filter material has good permeability for liquids and gases, good filtration properties and a high retention capability for dirt particles. The polymer foam can likewise be simply mechanically worked and inserted as a filter cartridge.

### BRIEF DESCRIPTION OF THE DRAWINGS

The invention makes a wide variety of embodiments possible. In order to further clarify its basic principle, one of said embodiments is illustrated in the drawing and is described in the following.

### DETAILED DESCRIPTION OF THE INVENTION

A single FIGURE shows a fuel delivery unit 2 according to the invention inserted in a fuel tank 1.

The fuel delivery unit 2 has a fuel pump 4 which is arranged in a surge pot 3 and has a prefilter 5 arranged in the base region of the surge pot 3 and a fuel filter 6 which almost completely fills the space between the fuel pump 4 and the surge pot 3. The fuel pump 4 has a pump stage 8 which is driven by an electric motor 7 and has two impellers 9, 10 and, at its upper side, a connecting pipe stub 11. A supply line which leads to an internal combustion engine (not illustrated) can be connected to the connecting pipe stub 11. When the lower impeller 9 of the pump stage 8 is driven, fuel is drawn from the fuel tank 1 through the prefilter 5 and is delivered to the upper region of the surge pot 3 via an ascending pipe 12. The fuel subsequently flows through the fuel filter 6 to the upper impeller 10. From there, said fuel is delivered through the electric motor 7 to the connecting pipe stub 11. For clarity, the fuel flows are indicated by arrows in the drawing.

The fuel filter 6 has a filter material 13 which concentrically encloses the fuel pump 4. A recess 14 for holding the fuel pump 4 is arranged directly in the filter material 13. The fuel pump 4 has an interference fit in the recess 14 of the filter material 13. In addition, the filter material 13 is, for example, produced in one piece with the surge pot 3 by means of injection molding into the surge pot 3. The filter material 13 almost completely fills the space between the surge pot 3 and the fuel pump 4, and has damping properties for damping the noise of the fuel pump 4.

In one alternative embodiment, the filter material 13 is produced with an outer diameter which corresponds to the inner diameter of the surge pot 3 and with the recess 14 for the fuel pump 4, and is subsequently inserted in the surge pot 3.

1. A fuel delivery unit having a surge pot and a fuel pump which is fastened in the surge pot, having a fuel filter and having a sealing connection of the fuel filter to the surge pot and to the fuel pump, characterized in that a filter material (13) almost completely fills a space between the surge pot (3) and the fuel pump (4).

2. The fuel delivery unit as claimed in claim 1, characterized in that the filter material (13) is connected to the surge pot (3) in a cohesive fashion.

3. The fuel delivery unit as claimed in claim 1 or 2, characterized in that the filter material (13) is injection-molded into the surge pot (3).

4. The fuel delivery unit as defined in claim 1, wherein the filter material (13) is embodied as damping material of the fuel pump (4).

5. The fuel delivery unit as defined in claim 1, wherein the filter material (13) of the fuel filter (6) has a recess (14) for directly holding the fuel pump (4).

6. The fuel delivery unit as defined in claim 1, wherein the fuel pump (4) has an interference fit in the recess (14) of the filter material (13).

7. The fuel delivery unit as defined in claim 1, wherein the filter material (13) has a sponge-like structure.

8. The fuel delivery unit as defined in claim 1, wherein the filter material (13) is plugged into the surge pot (3).

9. The fuel delivery unit as defined in claim 7, wherein the filter material (13) is produced from open-cell metal foam.

10. The fuel delivery unit as defined in claim 7, wherein the filter material (13) is produced from polymer foam.
